(19) United States
(12) Patent Application Publication
(10) Pub. No.: US 2001/0030404 A1
(43) Pub. Date: Oct. 18, 2001

(54) Shock absorber for a scooter

(76) Inventor: Chieh-I Liu, Taipei (TW)

Correspondence Address: Alan Kamrath, Rider,Bennett,Egan & Arundel,LLP, 333 South Seventh Street, Suite 2000, Minneapolis, MN, 55402, US

(21) Appl. No.: 09/726,178

(22) Filed: Nov. 29, 2000

(30) Foreign Application Priority Data
Apr. 18, 2000 (TW) 089206298

(51) Int. Cl. B62M 1/00; A63C 17/00

(52) U.S. Cl. 280/87.041

(57) ABSTRACT

A shock absorber for a scooter has a front shock absorber which is applied to a front wheel of the scooter and a rear shock absorber which is applied to a rear wheel of the scooter. When the scooter is ridden over a bumpy surface, both the shock absorbers minimize shocks to the scooter emanating from the bumpy surface.

### BACKGROUND OF THE INVENTION

1. Field of the Invention

The present invention is related to a shock absorber, and more particularly to a shock absorber for a scooter which effectively minimizes shocks when the scooter is ridden over bumpy surfaces.

2. Description of Related Art

Recently a scooter has become a popular vehicle for riding short distances due to its light weight and small volume, as well as its fun-to-ride aspect. Generally, a scooter comprises of a body, a handlebar, a front wheel, and a rear wheel. However, the wheels of the scooter are made of hard rubber and so the scooter can not absorb shocks when it is ridden over bumps because the material of the wheels lacks resilience.

When the scooter is ridden over bumpy surfaces, etc, the rider will experience shock and discomfort, as well as danger through the chance that control is lost due to the lack of effective shock absorbency.

To overcome the shortcomings, the present invention tends to provide a shock absorber for a scooter to mitigate and obviate the aforementioned problems.

### SUMMARY OF THE INVENTION

The main objective of the invention tends to provide a shock absorber for a scooter which effectively minimizes shocks when the scooter is ridden over bumpy surfaces.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a shock absorber applied in a scooter in accordance with the present invention, wherein the scooter is shown in partial portion;

FIG. 2 is a side view of the shock absorber applied in the scooter in accordance with the present invention; and

FIG. 3 is a schematic view of the shock absorber applied in the scooter in accordance with the present invention, wherein the scooter is experiencing a shock due to a bumpy surface.

### DETAILED DESCRIPTION OF THE PREFERRED EMBODIMENT

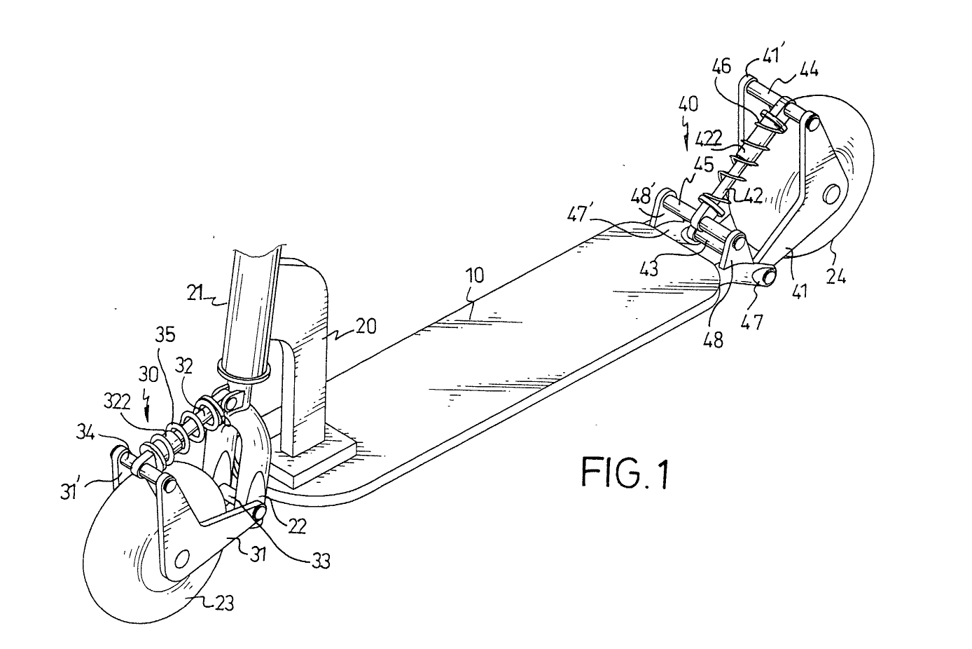

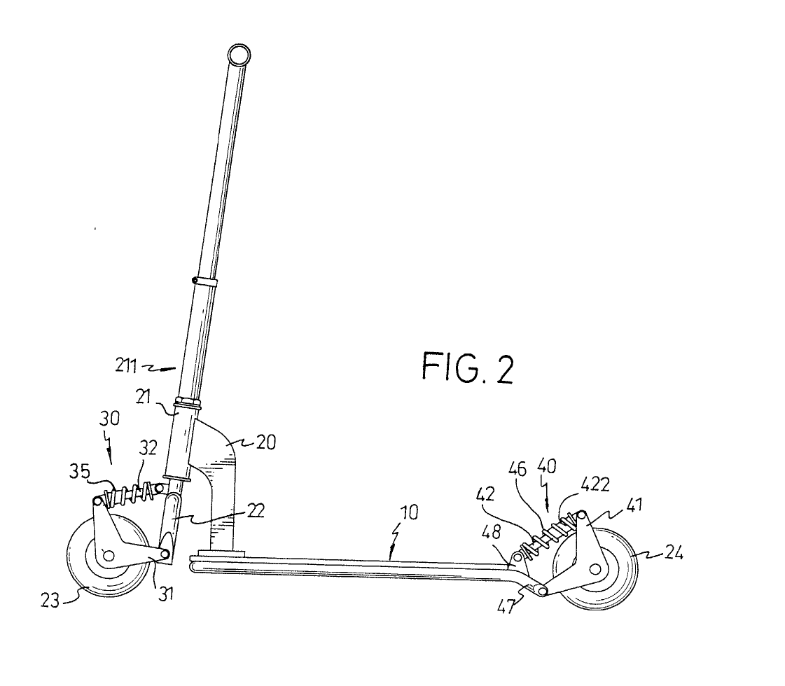

With reference to FIG. 1 and FIG. 2, a partial portion of a scooter fitted with shock absorbers in accordance with the present invention is shown. The scooter has a body (10), a handlebar base (20) securely mounted on a front end of the body (10), a head tube (21) that a handlebar stem (211) pivotally extends wherein connected to the handlebar base (20), a wheel base (22) connected to an end of the head tube (21), a front shock absorber (30), and a rear shock absorber (40).

The front shock absorber (30) comprises two front V-shaped pieces (31 and 31′), a front piston (32) extending from a front housing (322), a first pin (33), a second pin (34) and a first spring (35).

First ends of both front V-shaped pieces (31 and 31′) are pivotally connected to the wheel base (22) by a first pin (33) and second ends of both front V-shaped pieces (31 and 31 ′) are also pivotally connected by the second pin (34). A front wheel (23) is rotatably connected between the front V-shaped pieces (31 and 31 ′). The front piston (32) has a first end slidingly received in the front housing (322), and a second end pivotally secured to a joint of the head tube (21) and the wheel base (22). The front housing (322) has a first end defining an opening into which the front piston (32) is securely yet slidingly received and a second end pivotally secured to the second pin (34), wherein a first spring (35) is mounted around the front piston (32) and the front housing (322).

The rear shock absorber (40) comprises two rear V-shaped pieces (41 and 41′), a rear piston (42) extending from a rear housing (422), a third pin (43), a fourth pin (44), a fifth pin (45), a second spring (46), two bases (47 and 47′) and two triangle pieces (48 and 48′).

The two bases (47 and 47′) are securely connected to a rear portion of the body (10) and extend from opposed sides of the body (10). The two triangle pieces (48 and 48′) are respectively formed on the bases (47 and 47′).

First ends of both rear V-shaped pieces (41 and 41 ′) are pivotally connected to the respective bases (47 and 47′) with the third pin (43) and second ends of both rear V-shaped pieces (41 and 41′) are pivotally connected with the fourth pin (44) extending therebetween. The fifth pin (45) is pivotally connected between the two triangle pieces (48 and 48′). A rear wheel (24) is rotatably connected between the two rear V-shaped pieces (41 and 41 ′). The rear piston (42) has a first end slidingly received in the rear housing (422), and a second end pivotally secured to the fifth pin (45). The rear housing (422) has a first end defining an opening into which the rear piston (42) is securely yet slidingly received and a second end pivotally secured to the fourth pin (44), wherein the second spring (46) is mounted around the rear piston (42) and the rear housing (422).

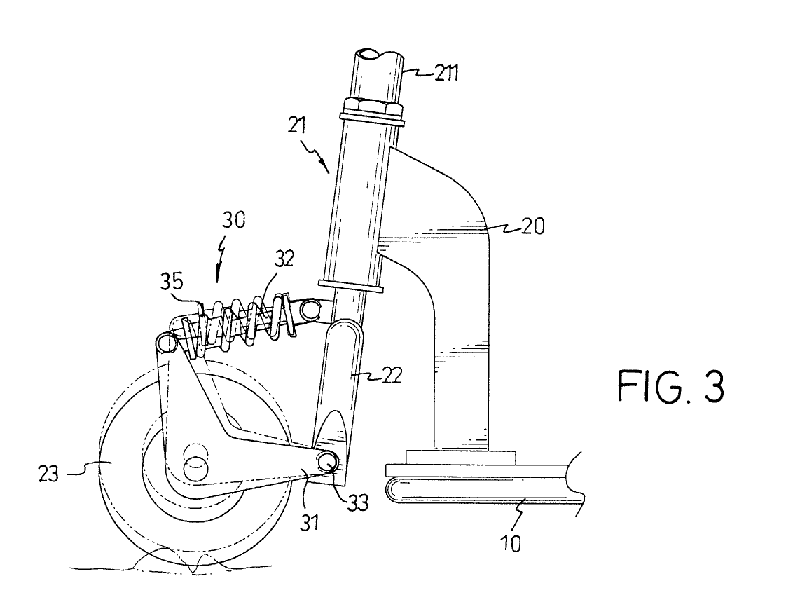

With reference to FIG. 3, wherein only the front portion of the scooter and the front shock absorber (30) are shown, when the scooter is ridden over a bumpy surface, the front V-shaped pieces (31 and 31′) are pivoted upward about the first pin (33) due to the front wheel (23) encountering bumps, whereby the first spring (35) is temporarily compressed and the shock to the scooter is minimized. The rear shock absorber (40) function in a manner the same as the front shock absorber (30).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A shock absorbing device for a scooter which is composed of a body, a handlebar stem pivotally extended from a head tube a first end of which is connected to a handlebar base that is securely mounted on the body, a wheel base connected to a second end of the head tube, a front wheel rotatably mounted in a front portion of the body and a rear wheel rotatably mounted in a rear portion of the body, the shock absorber device comprising:
a front shock absorber adapted to operationally mount between the front wheel and a joint of the head tube and the wheel base for effectively minimizing shocks when the scooter is ridden over bumpy surfaces; and
a rear shock absorber operationally adapted to operationally mount between the rear wheel and the rear portion of the body for effectively minimizing shocks when the scooter is ridden over the bumpy surfaces.

2. The shock absorber for a scooter as claimed in claim 1, the front shock absorber further comprising:
two front V-shaped pieces adapted to pivotally mount in opposed sides of the front wheel, wherein first ends of the two front V-shaped pieces are adapted to pivotally connect to the wheel base with a first pin, and second ends of the two front V-shaped pieces are adapted to pivotally connect with a second pin;
a front piston extending from a front housing, wherein the front piston has a first end slidingly received in the front housing, and a second end adapted to pivotally secure to the joint of the head tube and the wheel base and, the front housing has a first end defining an opening into which the front piston is securely yet slidingly received and a second end pivotally secured to the second pin; and
a first spring mounted around the front piston and the front housing for absorbing a shock from the scooter.

3. The shock absorber for a scooter as claimed in claim 1, the rear shock absorber further comprising:
two bases adapted to extend from the rear portion and opposed sides of the body;
two triangle pieces respectively formed on the two bases;
two rear V-shaped pieces adapted to pivotally mounted in opposed sides of the rear wheel, wherein first ends of the two rear V-shaped pieces are pivotally connected to the respective two bases with a third pin and second ends of the two V-shaped pieces are pivotally connected with a fourth pin extending therebetween;
a fifth pin pivotally connected between the two triangle pieces;
a rear piston extending from a rear housing, wherein the rear piston has a first end slidingly received in the rear housing, and a second end pivotally secured to the fifth pin, and the rear housing has a first end defining an opening into which the rear piston is securely yet slidingly received and a second end pivotally secured to the fourth pin; and
a second spring mounted around the rear piston and the rear housing for absorbing the shock from the scooter.

4. The shock absorber for a scooter as claimed in claim 2, the rear shock absorber further comprising:
two bases adapted to extend from the rear portion and opposed sides of the body;
two triangle pieces respectively formed on the two bases;
two rear V-shaped pieces adapted to pivotally mounted in opposed sides of the rear wheel, wherein first ends of the two rear V-shaped pieces are pivotally connected to the respective two bases with a third pin and second ends of the two V-shaped pieces are pivotally connected with a fourth pin extending therebetween;
a fifth pin pivotally connected between the two triangle pieces;
a rear piston extending from a rear housing, wherein the rear piston has a first end slidingly received in the rear housing, and a second end pivotally secured to the fifth pin, and the rear housing has a first end defining an opening into which the rear piston is securely yet slidingly received and a second end pivotally secured to the fourth pin; and
a second spring mounted around the rear piston and the rear housing for absorbing the shock from the scooter.
